(19) United States
(12) Patent Application Publication
(10) Pub. No.: US 2010/0231112 A1
(43) Pub. Date: Sep. 16, 2010

(54) Backlight module lamp

(76) Inventor: Han-Ming Lee, Hsin Chu City (TW)

Correspondence Address: LEE, Han-Ming, P.O. Box 7-820, TAIPEI, TW

(21) Appl. No.: 12/381,295

(22) Filed: Mar. 11, 2009

(51) Int. Cl. H01J 7/44

(52) U.S. Cl. 313/1

(57) ABSTRACT

The present invention relates to a backlight module lamp, comprising two conducting brackets, chips, conducting wires, the lower sealing block, upper sealing block, and lamp cover. The main improvements including: the chip cup on one of the conducting pins is designed as a rectangle concave taper chip cup for the light source of a plurality of chips inserted to be reflected as fully straight light rays, the backlight module display panel is embedded via the front opening of the lamp cover to create equal brightness for the long-distance panel, therefore fully overcome the deficiency of unequal brightness for the short-distance light source of traditional round chip cups to achieve the industrial use of long-distance fully straight light rays.

### BACKGROUND OF THE INVENTION

Presently, the liquid crystal panel display information structure technology is widely used in electronic products such as mobile phones, intelligent PDA, IPOD, GPS navigators, video cameras, cameras, LCD, LCD TVs, and NB, etc. This technology generally adopts panels with micro cold cathode tube lamps provided on the two sides to trigger the ringed light source and introduce it into the panels. With its large size and complexity, the said method is replaced by new LED technologies. However, the LED chip cup is of a round structure, causing the light source to radiate and the brightness generated is concentrated on the side of the panel, creating unequal brightness on the panel, making it necessary to improve and perfect the LED lamp structure.

### SUMMARY OF THE INVENTION

The primary purpose of the present invention is to provide a backlight module lamp and in particular one comprising two conducting brackets, chips, conducting wires, the lower sealing block, upper sealing block, and lamp cover to achieve the industrial use of long-distance fully straight light rays.

The secondary purpose of the present invention is to provide a backlight module lamp and in particular one wherein the chip cup on one of the conducting pins is designed as a rectangle concave taper chip cup for the light source of a plurality of chips inserted to be reflected as fully straight light rays.

Another purpose of the present invention is to provide a backlight module lamp and in particular one wherein an opening is provided on the upper side of the lamp cover for the embedded backlight module display panel to be exposed to the light to generate the effect of equal brightness for the long-distance panel.

### BRIEF DESCRIPTION OF THE DRAWINGS

FIG. 1 is a 3D diagram of the present invention.

FIG. 2 is a schematic diagram of the components of the present invention.

FIG. 3 is a cross-section 3D diagram of the present invention.

FIG. 4 is a schematic of the chip cup of the present invention reflected as fully straight light rays.

FIG. 5 is a schematic of the backlight module display panel of the present invention embedded into the lamp cover groove.

FIG. 6 is a schematic of embodiment of another longer chip cup of the present invention.

FIG. 7 is a schematic of the embodiment of another chip cup structure of the present invention.

### DETAILED DESCRIPTION OF THE PREFERRED EMBODIMENT

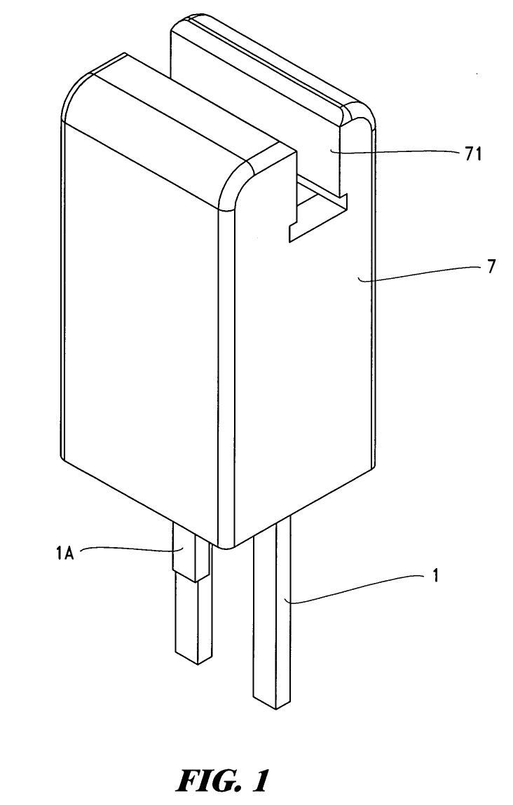

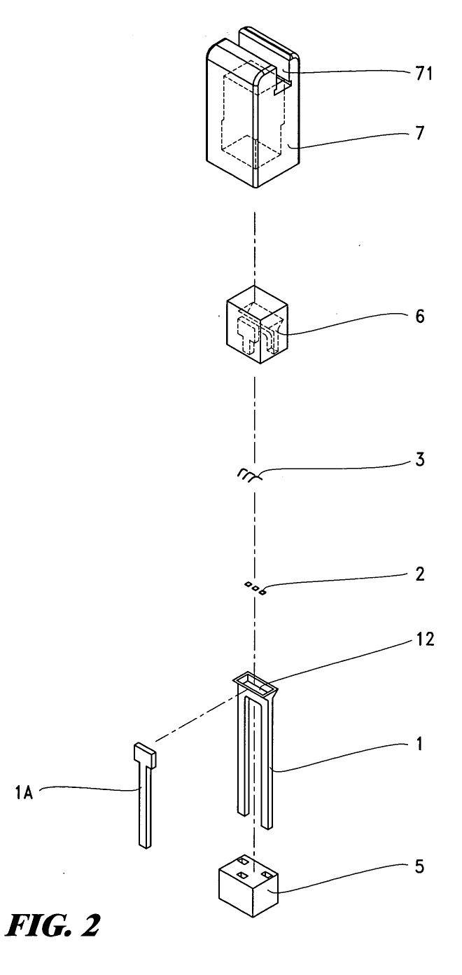

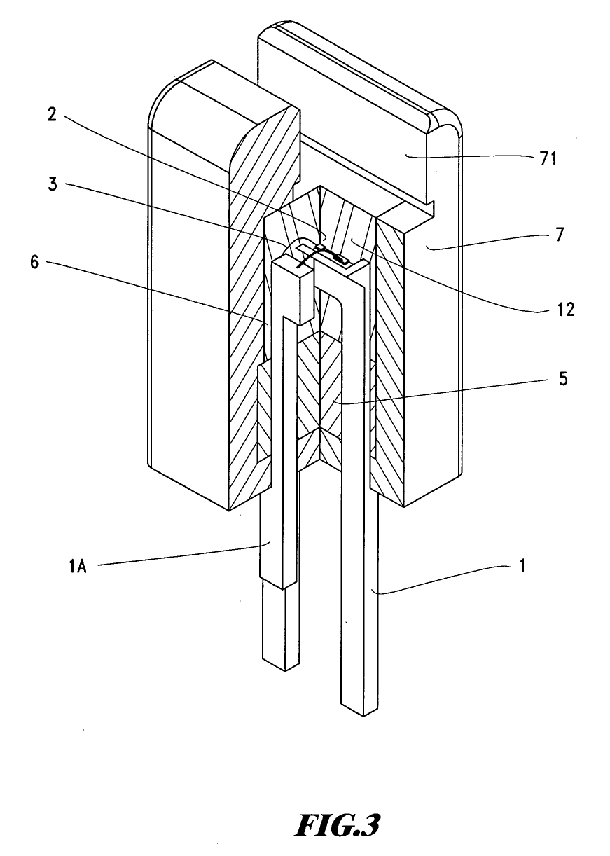

Please refer to FIGS. 1 through FIGS. 3, the present invention is related to a backlight module lamp, comprising two conducting brackets 1 and 1A, chips 2, conducting wires 3, the lower sealing block 5, upper sealing block 6, and lamp cover 7; the two conducting brackets 1 and 1A are of traditional LED conducting bracket structure, wherein the chip cup on the upper side of the conducting bracket 1 is designed as a rectangle concave taper chip cup 12; chips 2 are lighting semi-conductor chips to be inserted into the rectangle concave taper chip cup 12 of the conducting bracket 1; conducting wires 3 are made of conducting material, connected to chips 2 on one end and to the upper end of the conducting bracket 1A on the other end; the lower sealing block 5 is a trapezoidal injection sealed and attached to the middle section of the two conducting brackets 1 and 1A; the upper sealing block 6 is a trapezoidal injection sealed and attached to the upper end of the two conducting brackets 1 and 1A; the lamp cover 7 is a rectangle injection sealed to the upper sealing block 6 and the lower sealing block 5 and an opening concave groove 71 is provided at the front of the lamp cover.

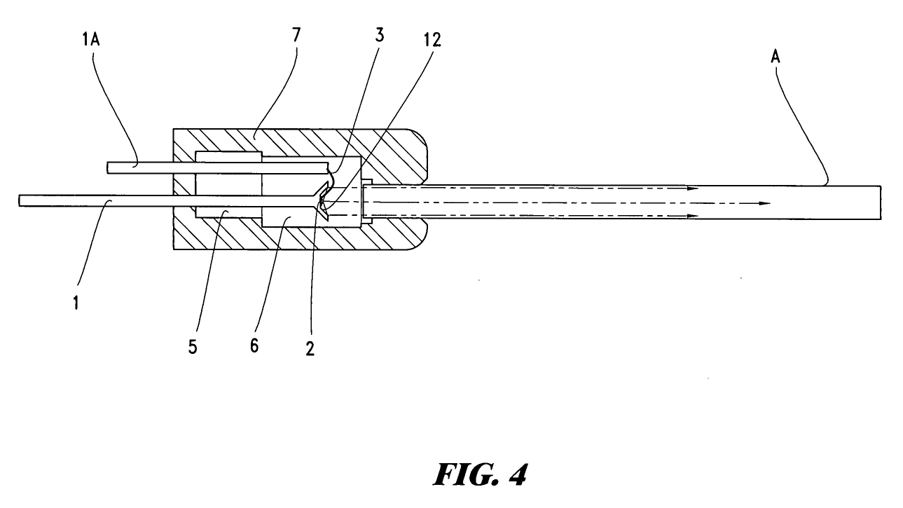

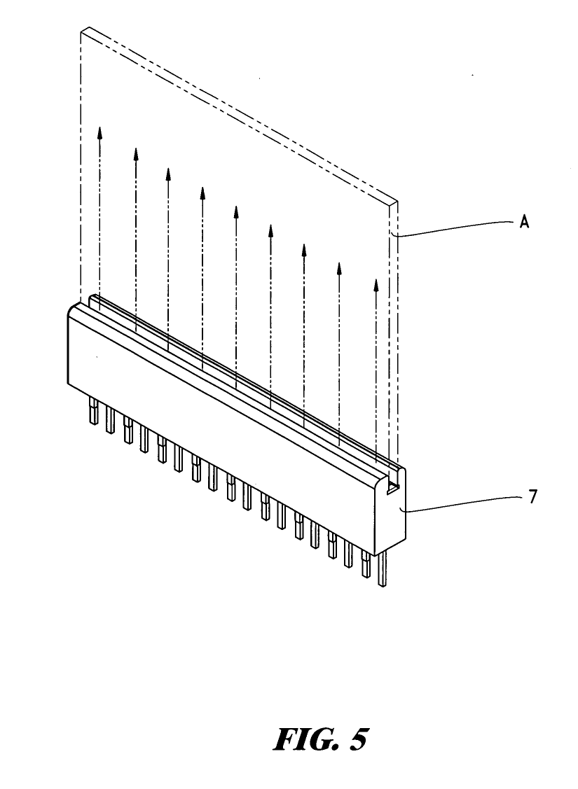

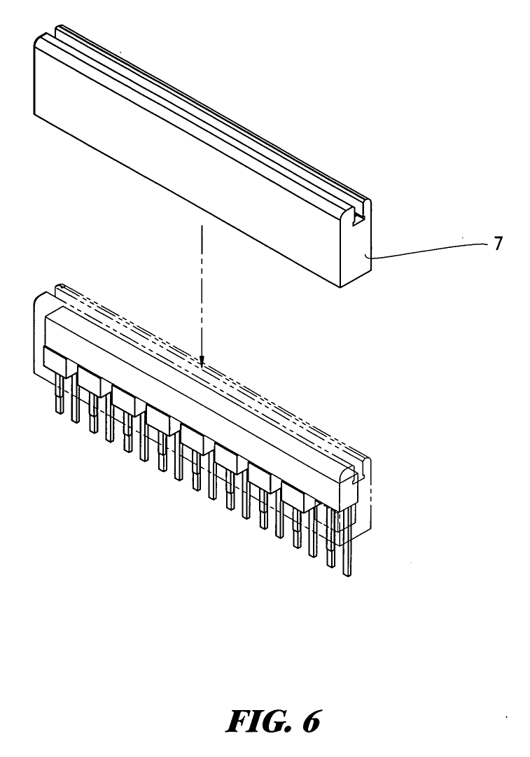

Please refer to FIGS. 4 through FIGS. 6 for the embodiment of the present invention. The chip cup on the upper side of the conducting bracket 1 is designed as a rectangle concave taper chip cup 12 for the light source of a plurality of chips 2 inserted to be reflected as fully straight light rays, which is then emitted via the opening concave groove 71 provided at the front of the lamp cover 7 The backlight module display panel A can be embedded into the concave groove 71 so as to create equal brightness for the long-distance panel, therefore fully overcome the deficiency of unequal brightness for the short-distance light source of traditional round chip cups to achieve the industrial use of long-distance fully straight light rays.

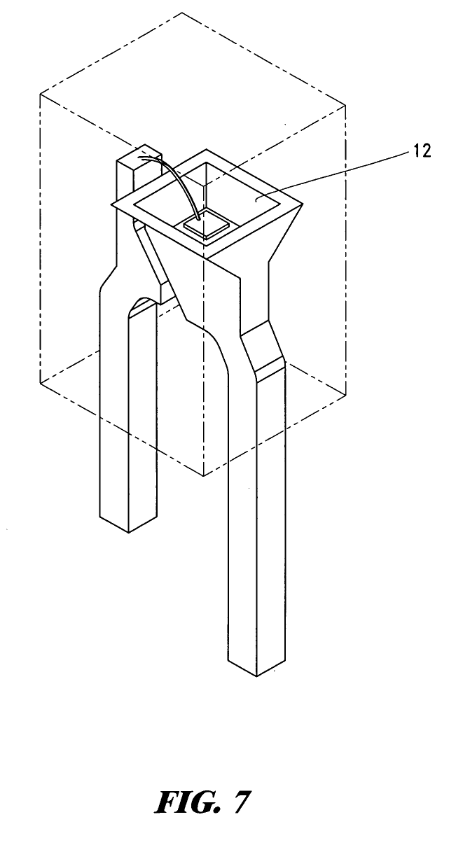

Please refer to FIG. 7, the chip cup 12 on the upper side of the conducting bracket 1 may also be square to provide the effect of fully straight light source of a single chip.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changers in the forms and details of the device illustrated and in its operation can be made by those skilled in the art without departing in any way from the spirit of the present invention.

I claim:

1. A backlight module lamp, comprising two conducting brackets, chips, conducting wires, the lower sealing block, upper sealing block, and lamp cover, wherein:
The two conducting brackets are of traditional LED conducting bracket structure, wherein the chip cup on the upper side of the conducting brackets is a rectangle concave taper chip cup;
The chips are lighting semi-conductor chips to be inserted into the rectangle concave taper chip cup of the conducting bracket;
The conducting wires are made of conducting material, connected to the chips in the chip cup on the upper side of the conducting bracket on one end and to the upper end of the other conducting bracket on the other end;
The lower sealing block is a trapezoidal injection sealed and attached to the middle section of the two conducting brackets;
The upper sealing block is a trapezoidal injection sealed and attached to the upper end of the two conducting brackets;
The lamp cover is a rectangle injection sealed to the upper sealing block and the lower sealing block and an opening concave groove is provided at the front of the lamp cover;
According to the above structure, the chip cup on the upper side of the conducting bracket is designed as a rectangle concave taper chip cup for the light source of a plurality of chips inserted to be reflected as fully straight light rays, which is then emitted via the opening concave groove provided at the front of the lamp cover so as to create equal brightness for the long-distance panel to achieve the industrial use of long-distance fully straight light rays.
